(19) United States
(12) Patent Application Publication
(10) Pub. No.: US 2019/0241444 A1
(43) Pub. Date: Aug. 8, 2019

(54) SOLAR HUMIDIFIER AND DEHUMIDIFIER DESALINATION METHOD AND SYSTEM FOR THE DESALINATION OF SALINE WATER

(71) Applicant: King Fahd University of Petroleum and Minerals, Dhahran (SA)

(72) Inventors: Fahad A. Al-Sulaiman, Dhahran (SA); M. A. Antar, Dhahran (SA); M. Ifras Zubair, Dhahran (SA); Salem A. Al-Dini, Dhahran (SA)

(21) Appl. No.: 15/892,006

(22) Filed: Feb. 8, 2018

(51) Int. Cl. C02F 1/14; C02F 1/12; B01D 1/30; B01D 1/16; B01D 1/14

(52) U.S. Cl. CPC C02F 1/14; C02F 1/12; C02F 2103/08; B01D 1/16; B01D 1/14; B01D 1/30

(57) ABSTRACT

A solar powered humidification-dehumidification desalination system comprises or consists of a supply of seawater or brackish water referred to hereinafter as saline water passing through a dehumidifier condenser. The saline water passes a dehumidifier condenser and is preheated in the dehumidifier condenser or immediately before the dehumidifier condenser and thereafter due to the condensation process. A single humidification stage or multiple humidification stages include humidifier(s) and respective solar collectors. The solar collectors heat water and the heated water passes through the respective dehumidifiers to evaporate the preheated saline water to thereby separate pure water from the brine. The heated air is reheated and recirculated through the humidifying stages and dehumidifier and the desalinated water from condensation in the dehumidifier is collected and processed. Recirculating the brine from each humidifier utilizes the latent heat therein for more efficient evaporation and less energy consumption.

### FIELD OF THE INVENTION

This invention relates to methods and systems for solar humidification/dehumidification desalination of saline water based on solar thermal energy integrated with evacuated tube collectors as well as flat plate, evacuated flat plate collector, concentrated solar collectors and alike, wherein operating parameters such as the maximum temperature of the water heater and the mass flowrate of the humidifier dehumidifier components are optimized.

### BACKGROUND OF THE INVENTION

Consumable freshwater is progressively becoming a scarce resource, mainly affecting dry regions and rural areas with deserts. However, a common advantage in such areas is the availability of abundant solar radiation. The use of solar energy for producing freshwater in such regions is an available solution to address the scarcity of freshwater.

Humidifier dehumidifier desalination methods and systems have a relatively high gained output ratio (GOR) and require relatively low capital investment and involve relatively simple mechanisms. Such systems generally include components such as heat supply systems, condensers, and evaporators along with an option for thermal storage. The process involves direct contact between warm saturated air and warm raw water allowing the air to reach a preferred humidity level which is followed by extraction of water vapor from humid air using a condenser. It should be recognized that while a single Humidifier dehumidifier is mentioned, multiple such subsystems may be incorporated.

The solar-powered humidification-dehumidification desalination system includes a supply of saline/brackish water passing through a dehumidifier/condenser. The saline/brackish water is preheated in the dehumidifier/condenser due to the condensation process. A plurality of humidifying stages includes respective humidifiers and respective solar collectors. The solar collectors heat air, and the heated air passes through respective humidifiers to evaporate the preheated saline/brackish water, and separating pure water vapor from the brine. The humid air is reheated and recirculated through the humidifying stages and solar heaters, and the desalinated water from the dehumidifier via condensation is collected and processed. The system recirculates the brine successively from each humidifier to the next for more efficient evaporation and less energy consumption.

### SUMMARY OF THE INVENTION

The solar powered humidification-dehumidification desalination system comprises or consists of a supply of seawater or brackish water referred to hereinafter as saline water passing through a dehumidifier condenser. The saline water passes a dehumidifier/condenser and is preheated therein. A plurality of humidifying stages includes humidifiers and respective solar collectors. The solar collectors heat air and the heated air passes through the respective humidifiers to evaporate the preheated saline water and separating pure water vapor from the brine. The heated air is reheated and recirculated through the humidifying stages and the dehumidifier, and desalinated water from condensation in the dehumidifier is collected and processed. The system recirculates the brine from one or more humidifiers utilizing the heat content therein for more efficient evaporation and less energy consumption. In the present system, seawater or brine released from the brine tank is circulated through the one or more humidifiers in series after preheating by use of a heat exchanger in the dehumidifier, from the last humidification stage in sequence to the first humidification stage before returning to the brine tank. These and other features of the present invention will become readily apparent from review of the following specification and drawings.

The invention will now be described in connection with the accompanying drawings wherein like reference numbers are used to identify like parts.

### DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of a two-stage humidification/dehumidification desalination system according to the prior art;

FIG. 2 is a schematic diagram of a humidification/dehumidification system in accordance with a preferred embodiment of the present invention;

FIG. 3 are plots of GOR as a function of MR used for Optimization;

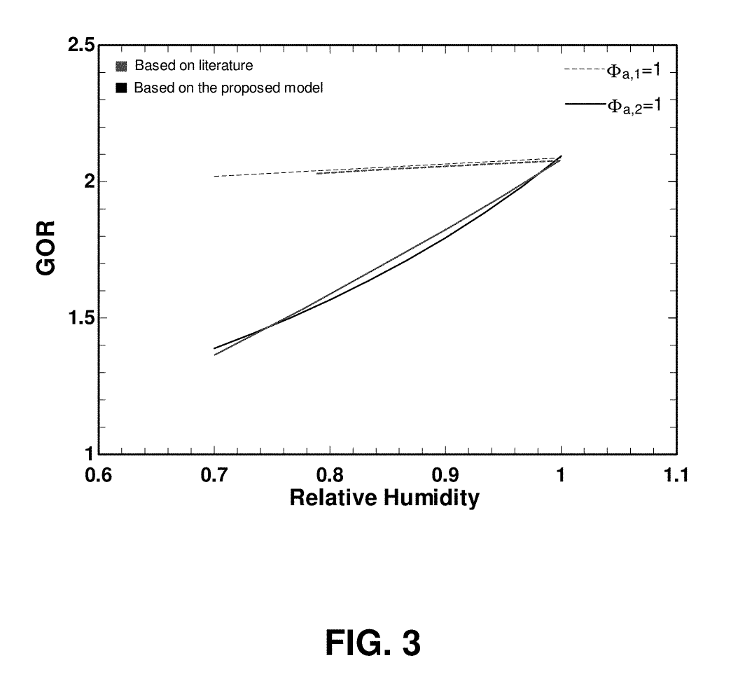

FIG. 4 is a daily total freshwater output as a function of the collector area;

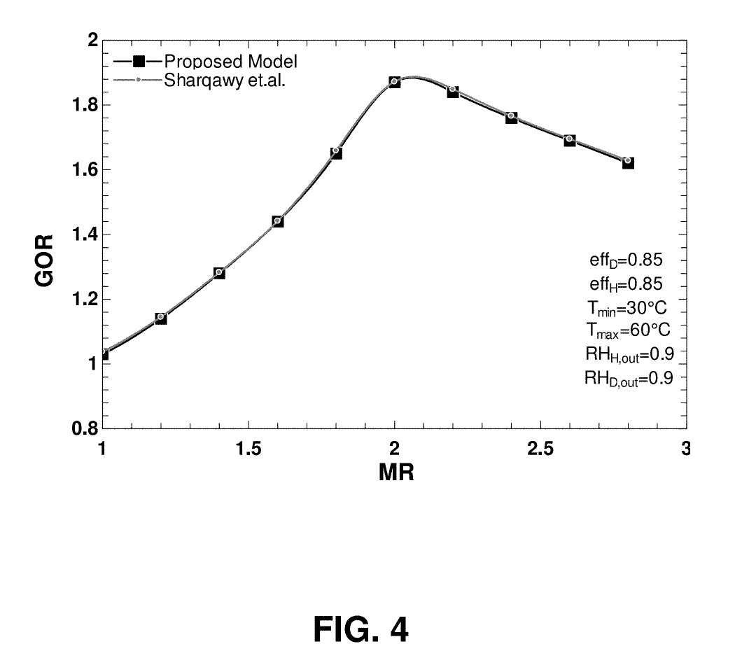

FIG. 5 is accumulated total freshwater production as a function of the time of the day for June;

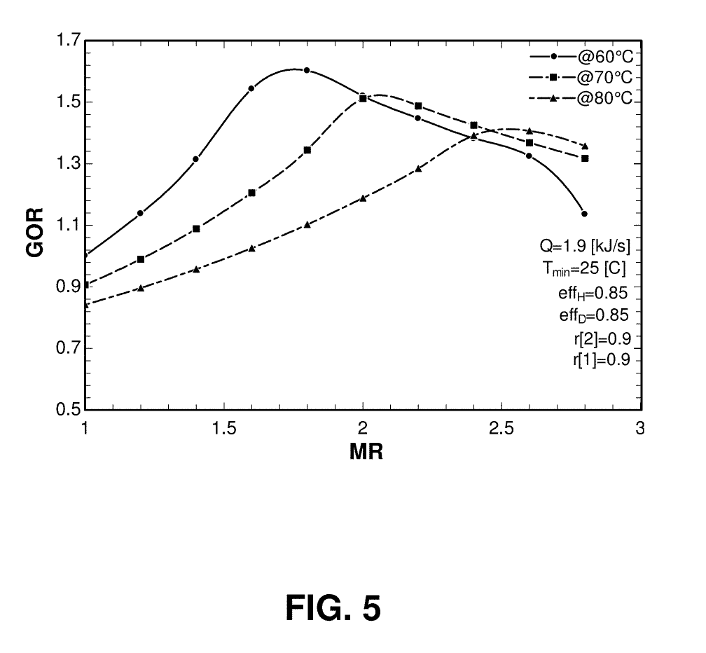

FIG. 6 is a daily averaged productivity for each month of the year;

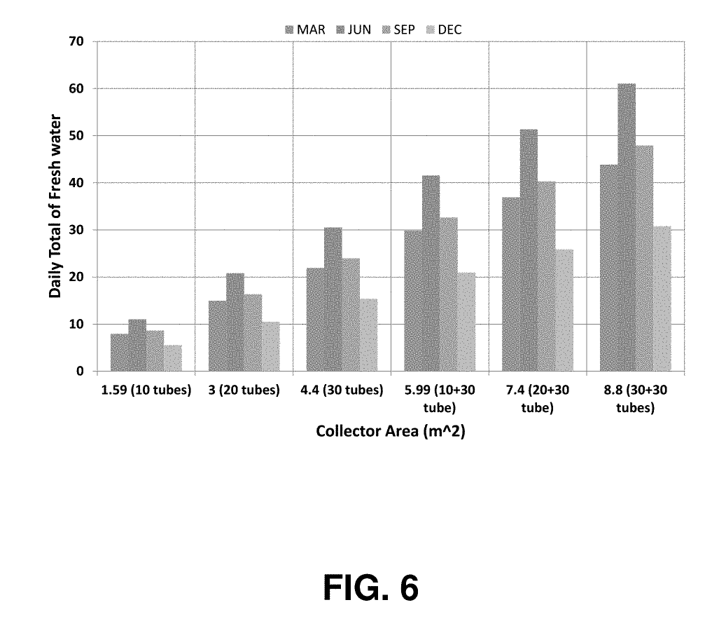

FIG. 7 is a variation of the daily averaged GOR over the course of the year;

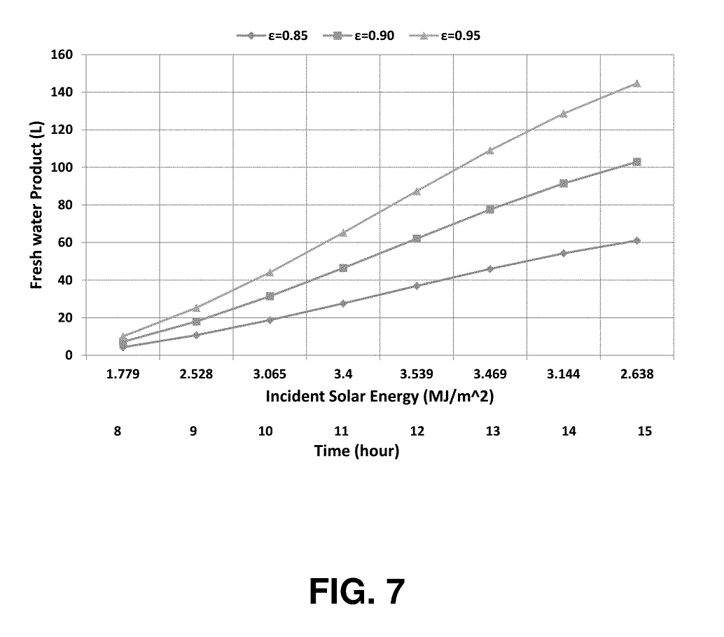

FIG. 8 is a freshwater production as a function of the hour of the day (March);

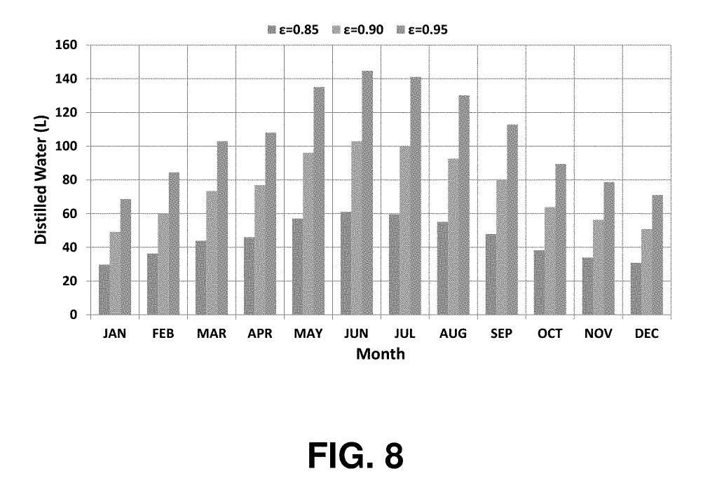

FIG. 9 is a freshwater production as a function of the hour of the day (June);

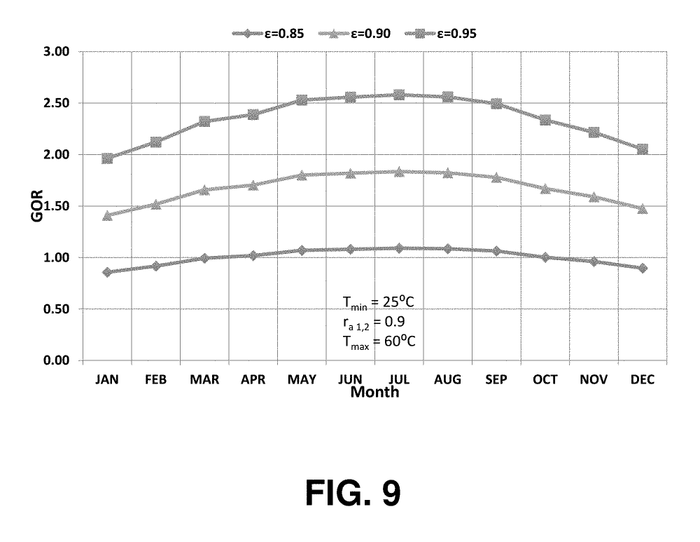

FIG. 10 is a freshwater production as a function of the hour of the day (September);

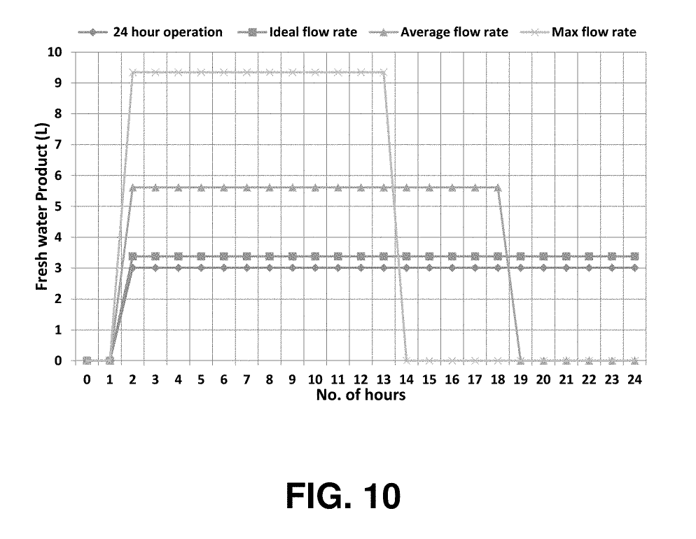

FIG. 11 is a freshwater production as a function of the hour of the day (December);

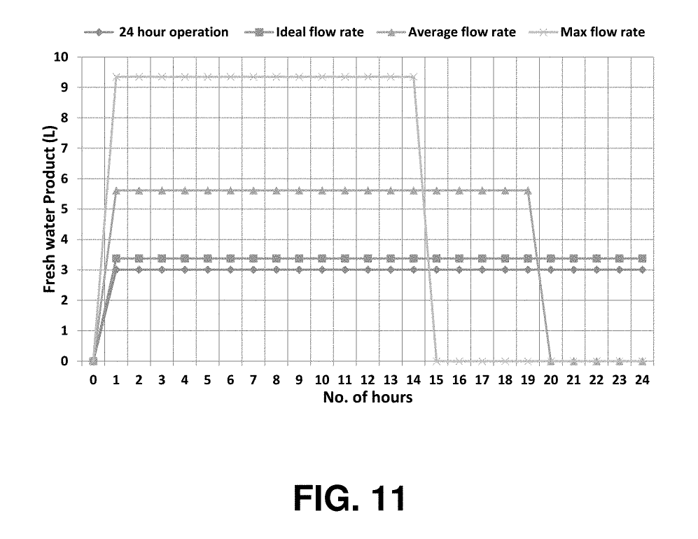

FIG. 12 is a total useful energy collected for the average day of each month;

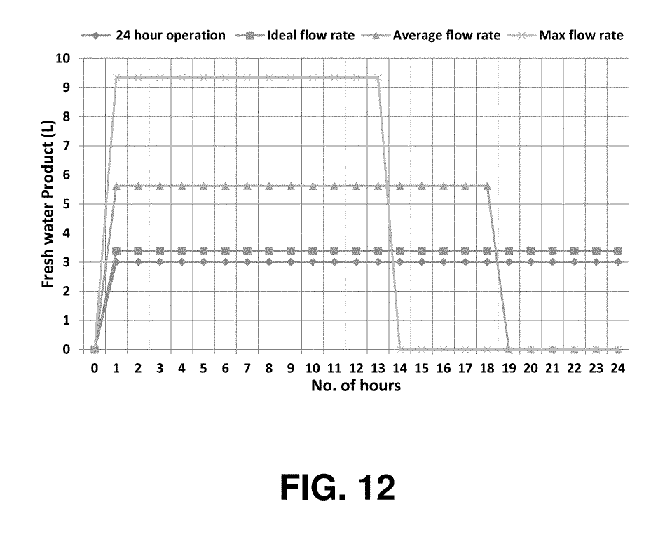

FIG. 13 is a total temperature variation during 24 hours (March);

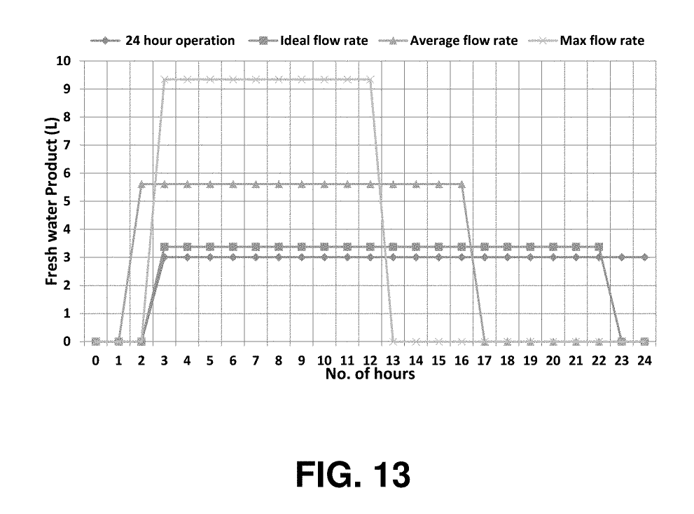

FIG. 14 is a tank temperature variation during 24 hours (June);

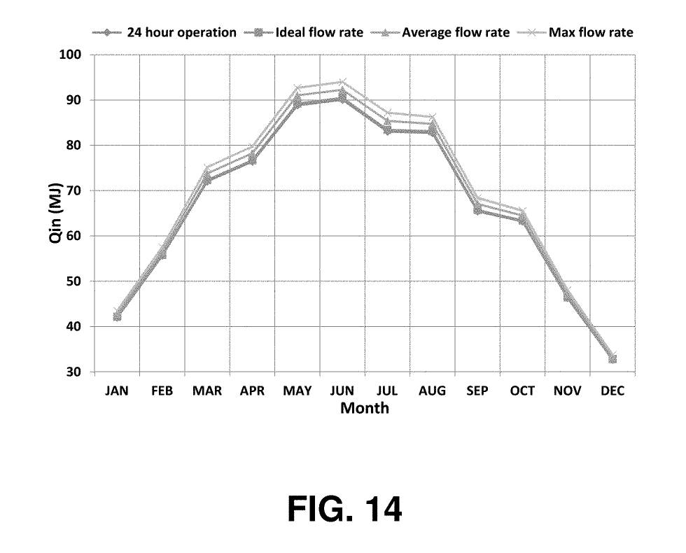

FIG. 15 is a tank temperature variation during 24 hours (September);

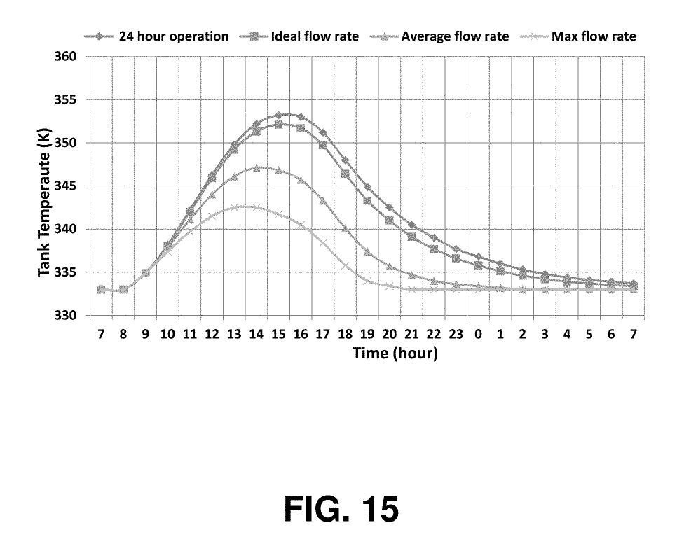

FIG. 16 is a tank temperature variation during 24 hours (December);

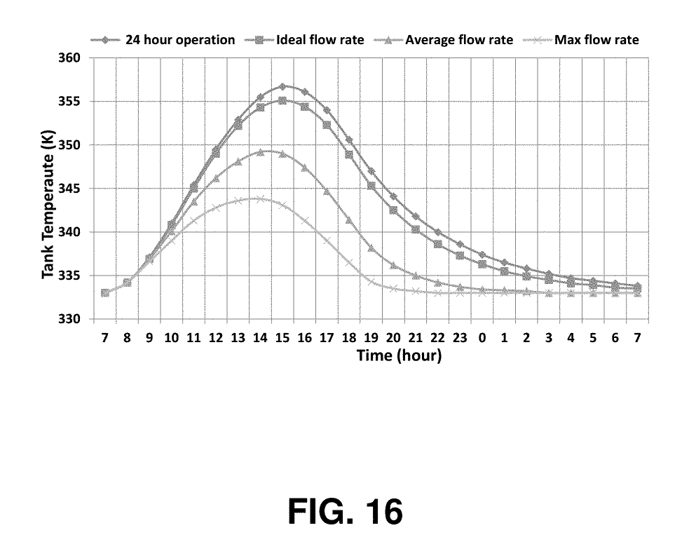

FIG. 17 is a plot of GOR as a function of the hour of the day (24-hour case);

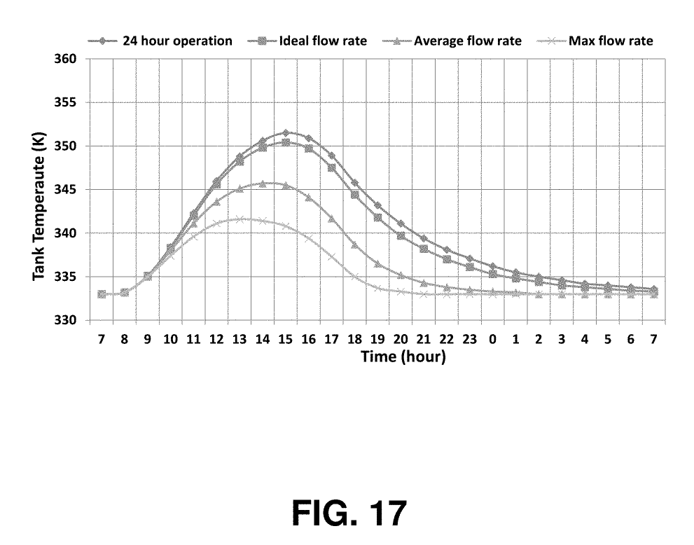

FIG. 18 is a plot of GOR as a function of the hour of the day (Ideal Flow case);

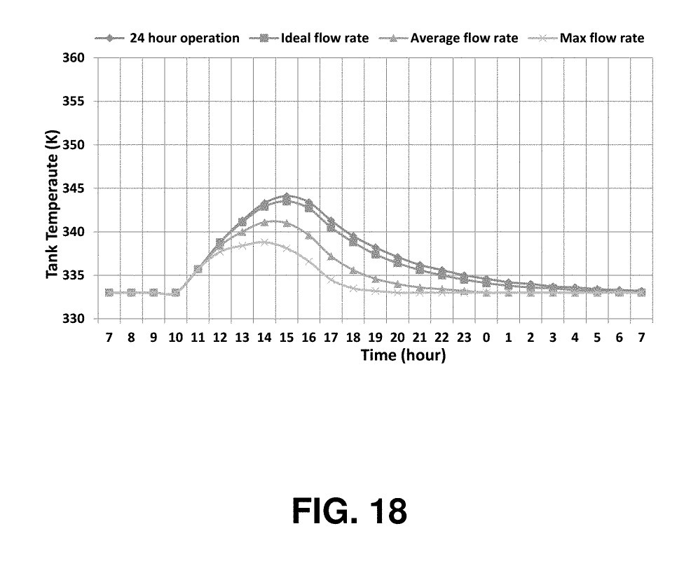

FIG. 19 is a plot of GOR as a function of the hour of the day (Average Flow case);

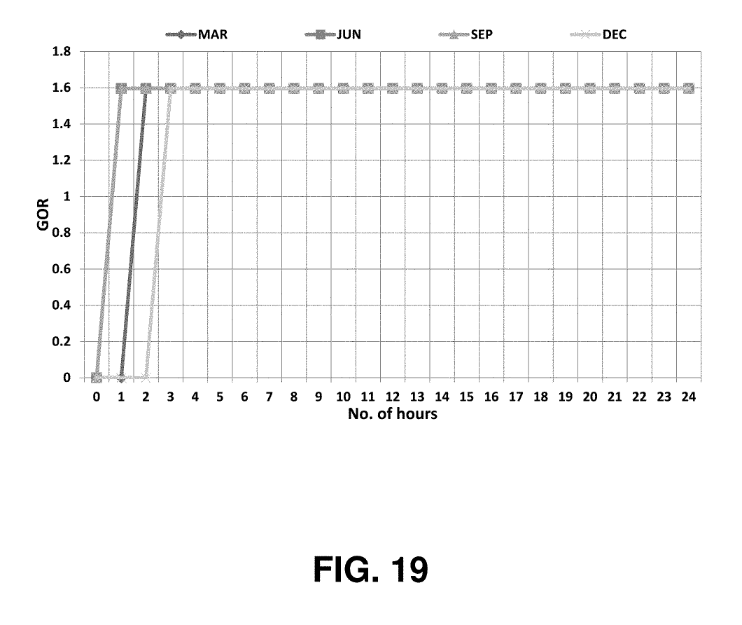

FIG. 20 is a plot of GOR as a function of the hour of the day (Maximum Flow case);

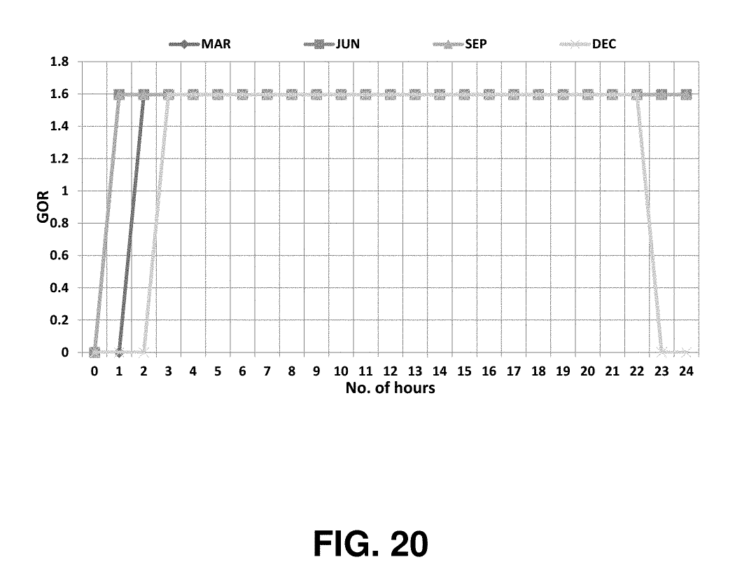

FIG. 21 is a heat input over the entire duration of the year at selected locations;

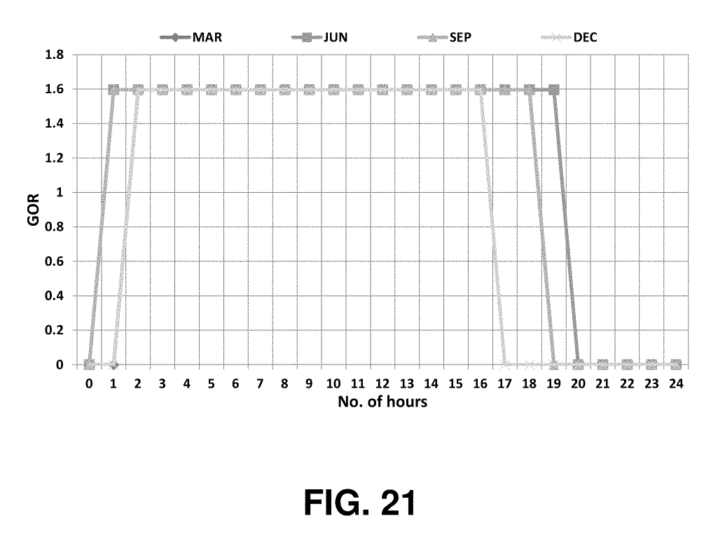

FIG. 22 is a plot of GOR as a function of the hour of the day (Maximum Flow case);

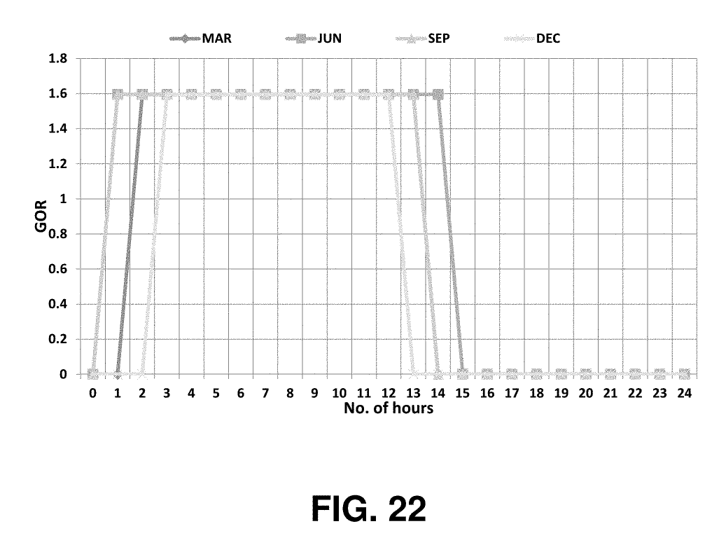

FIG. 23 is a heat input over the entire duration of the year at selected locations;

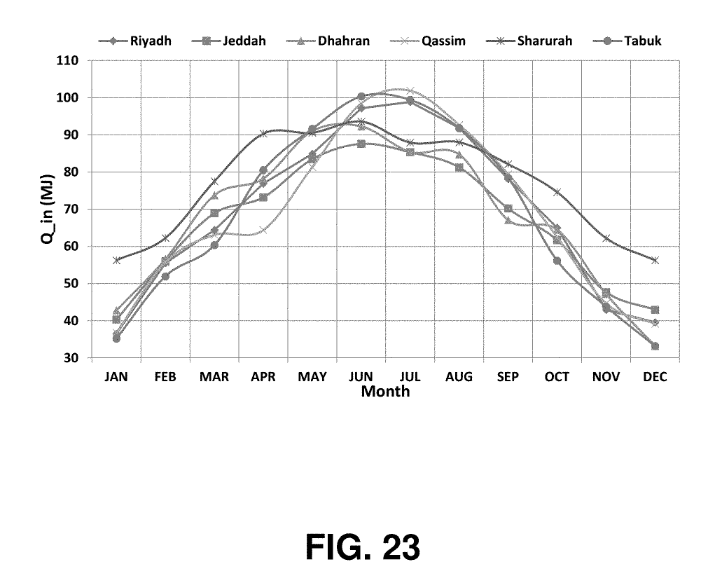

FIG. 24A is a storage tank temperature variation for the 24-hour case (March);

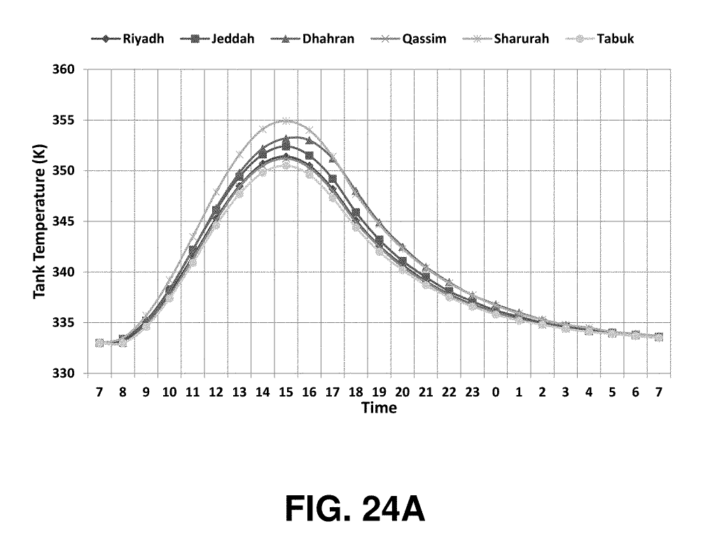

FIG. 24B is a storage tank temperature variation for the 24-hour case (June);

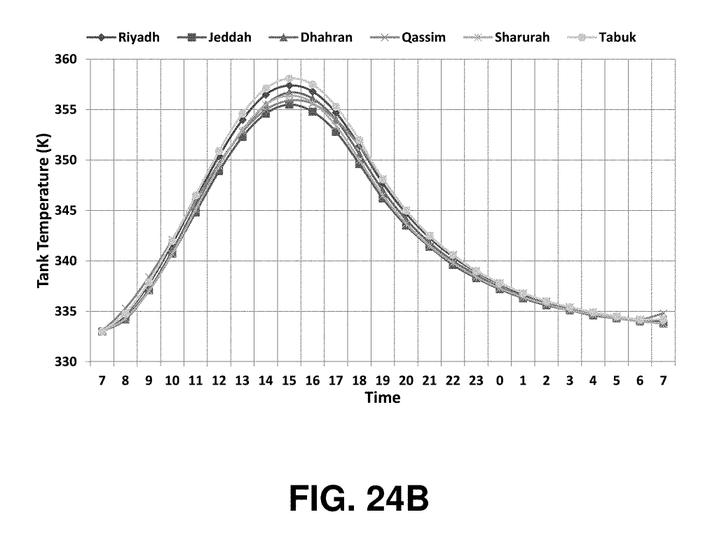

FIG. 24C is a storage tank temperature variation for the 24-hour case (September);

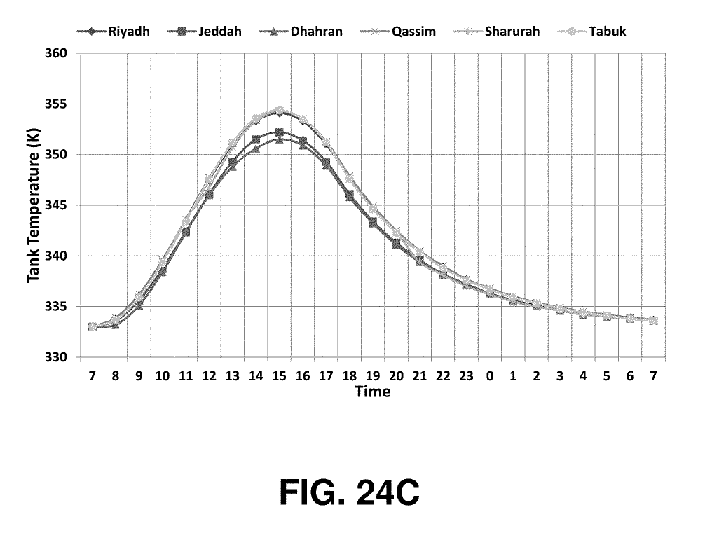

FIG. 24D is a storage tank temperature variation for the 24-hour case (December);

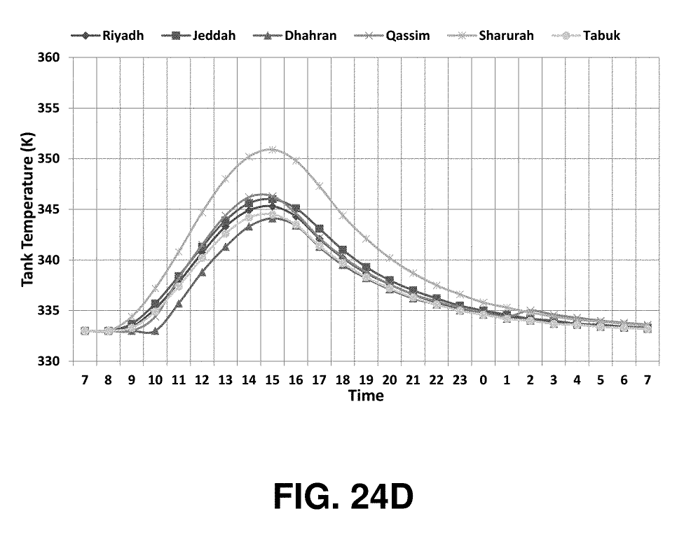

FIG. 25A is a storage tank temperature variation for the Ideal Flow case (March);

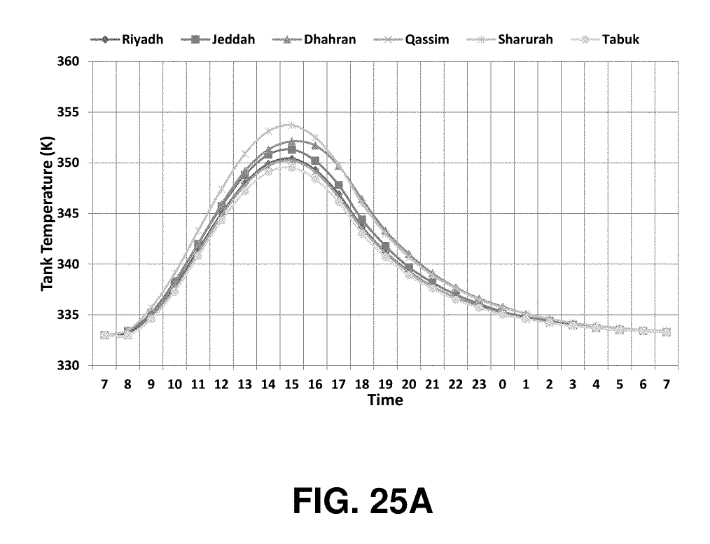

FIG. 25B is a storage tank temperature variation for the Ideal Flow case (June);

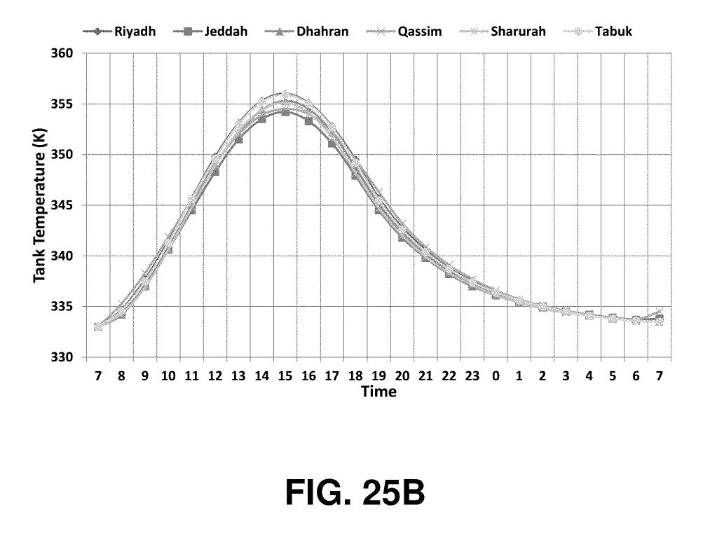

FIG. 25C is a storage tank temperature variation for the Ideal Flow case (September);

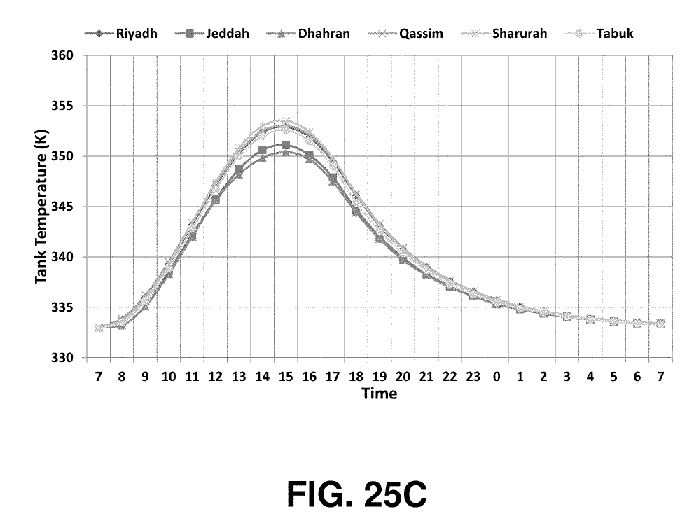

FIG. 25D is a storage tank temperature variation for the Ideal Flow case (December);

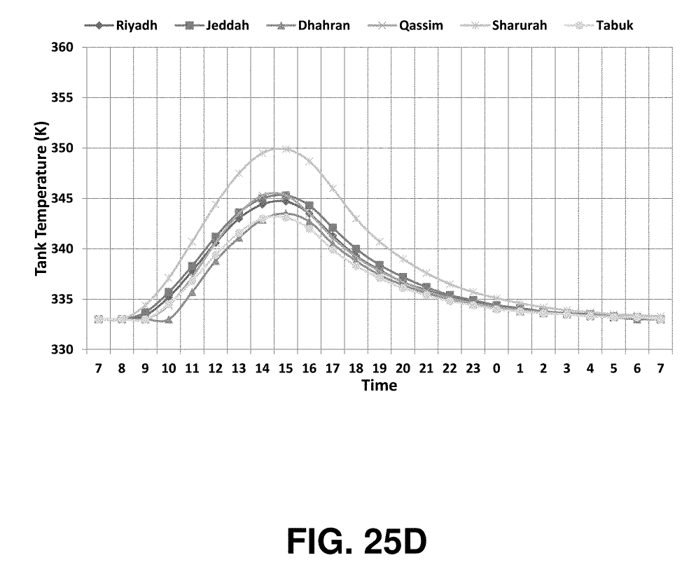

FIG. 26A is a storage tank temperature variation for the Average Flow case (March);

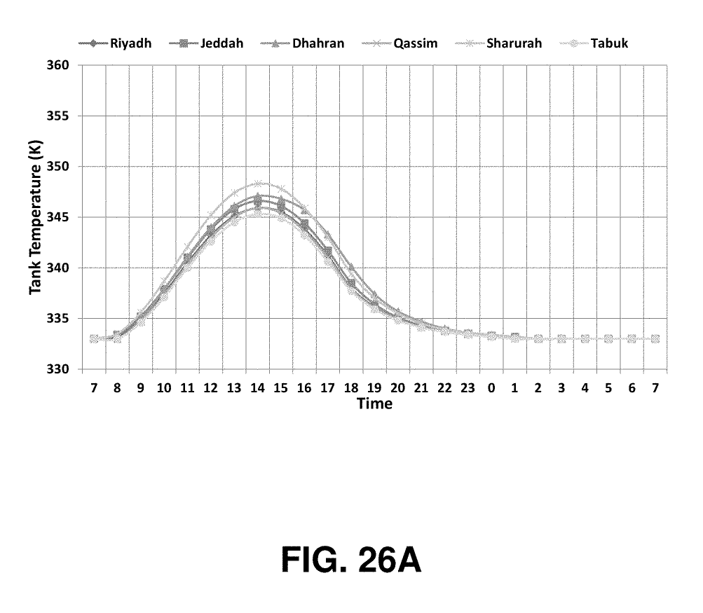

FIG. 26B is a storage tank temperature variation for the Average Flow case (June);

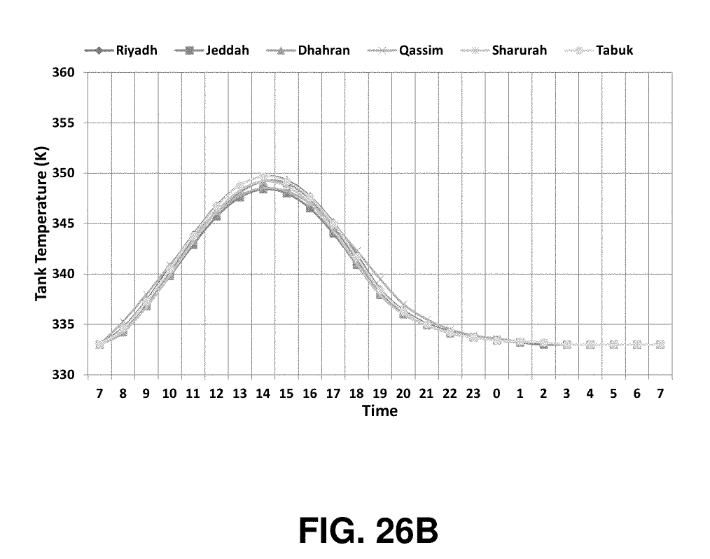

FIG. 26C is a storage tank temperature variation for the Average Flow case (September);

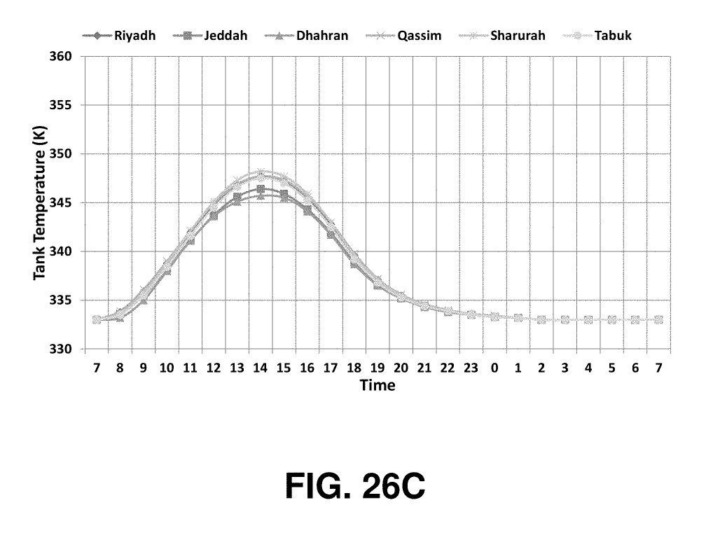

FIG. 26D is a storage tank temperature variation for the Average Flow case (December);

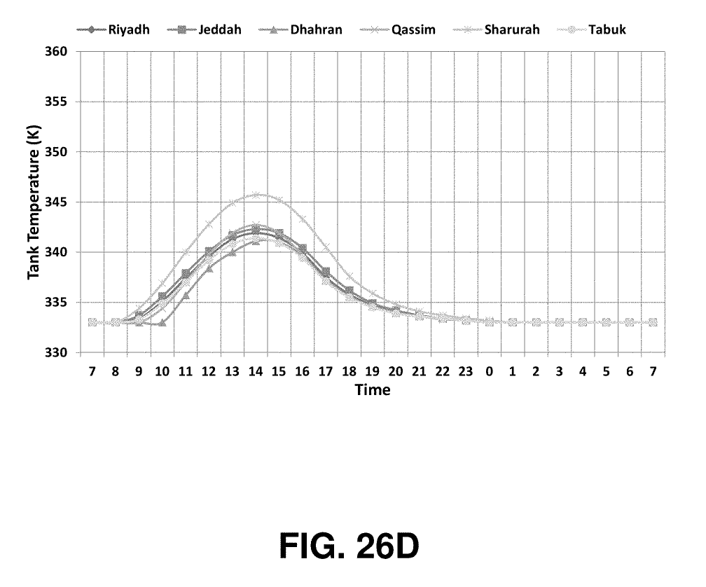

FIG. 27A is a storage tank temperature variation for the Maximum Flow case (March);

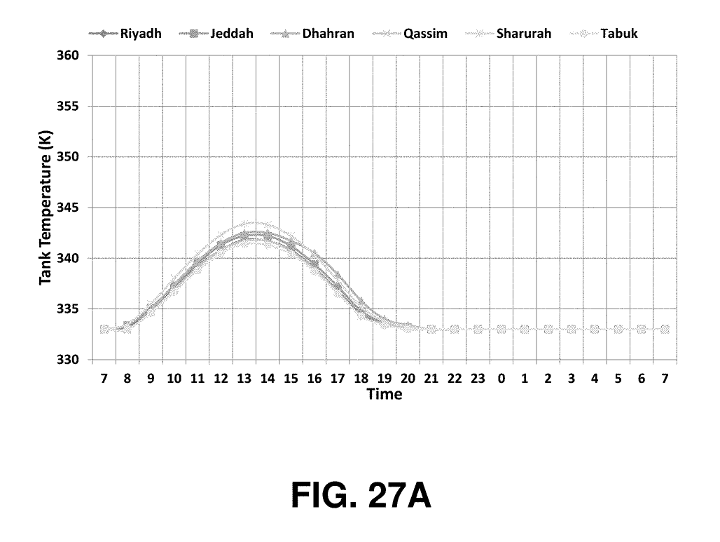

FIG. 27B is a storage tank temperature variation for the Maximum Flow case (June);

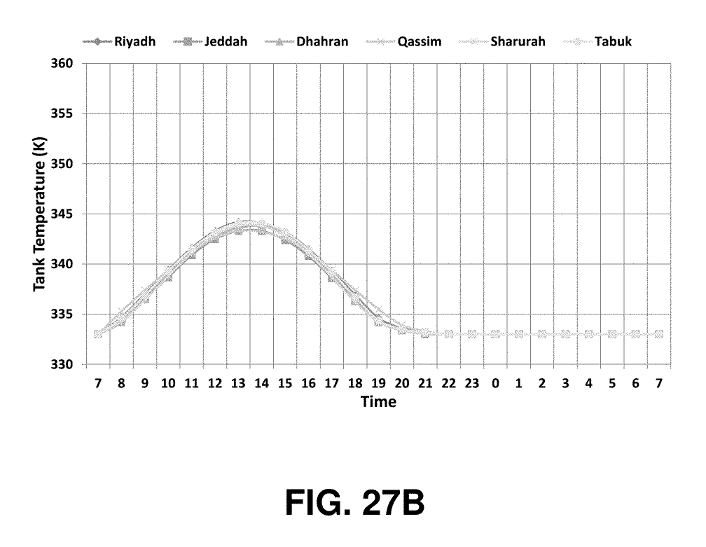

FIG. 27C is a storage tank temperature variation for the Maximum Flow case (September); and

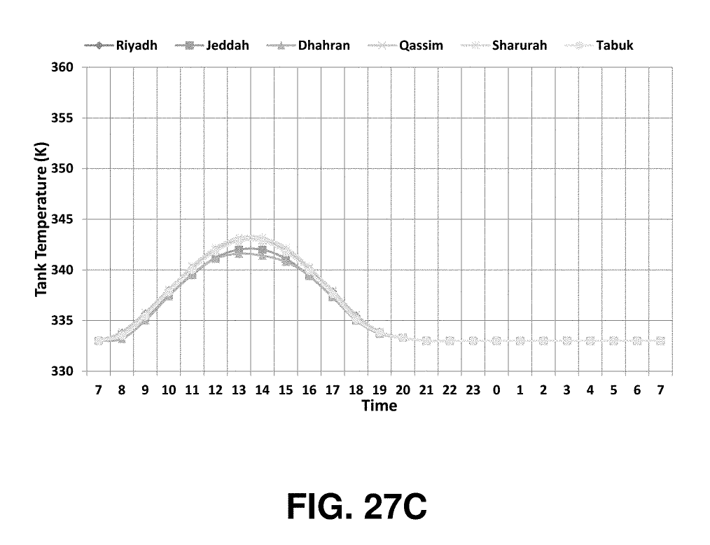

FIG. 27D is a storage tank temperature variation for the Maximum Flow case (December).

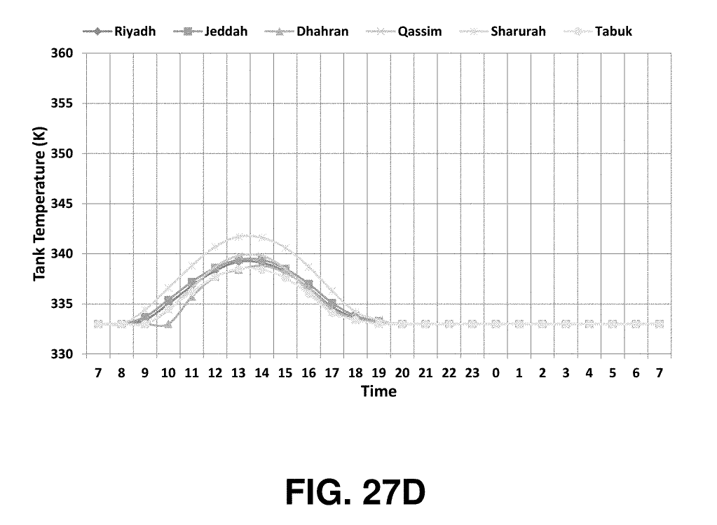

### DESCRIPTION OF THE PRIOR ART

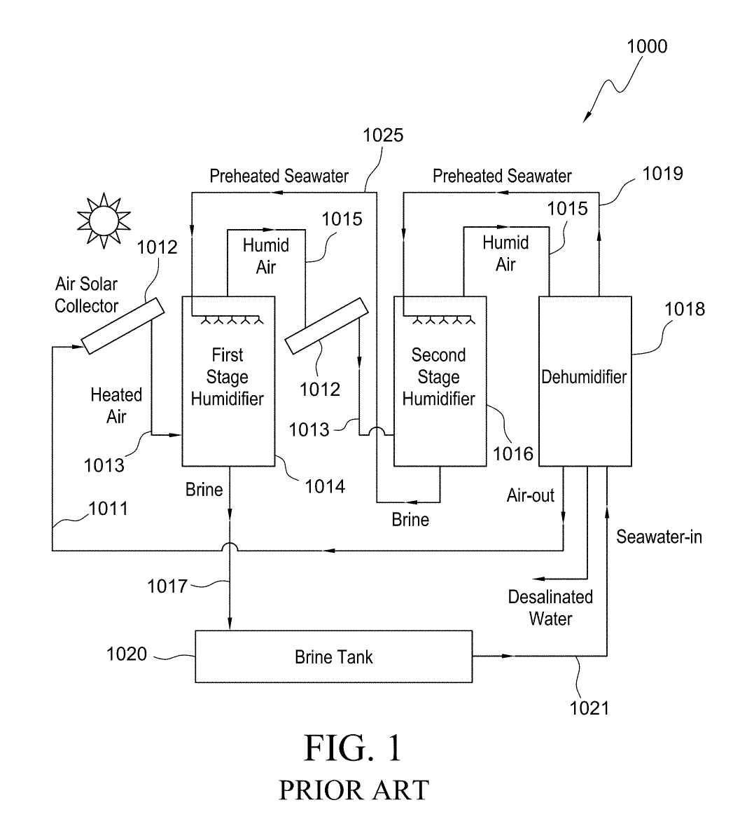

A prior art solar-powered humidifier-dehumidifier desalination system, hereinafter referred to as a multistage air-heated humidifier-dehumidifier MSAH-HDH desalination system, utilizes latent or residual heat energy in the brine to increase thermal efficiency and desalinated water production in the desalination process. As shown in FIG. 1, the MSAH-HDH desalination system 1000 is a two-stage process that includes a plurality of solar collectors 1012, each being operatively connected to a corresponding first-stage humidifier 1014 and a second-stage humidifier 1016. The solar collector 1012 adjacent the first stage humidifier 1014 supplies heated, relatively dry air 1013 for the humidification process, while the solar collector 1012 adjacent the second-stage humidifier 1016 reheats the humid air from the first-stage humidifier 1014. The heated air 1013 crosses streams with preheated brackish water or seawater 1019, 1025 sprayed inside the humidifiers 1014, 1016, causing evaporation. The relatively dry heated air 1013 becomes humid by water evaporated from the preheated brackish water 1019, 1025, thereby separating pure water from the brine.

Unlike the conventional HDH systems, the MSAH-HDH desalination system 1000 uses the residual or latent heat in the saline/brackish water to conserve energy required for the desired vaporization. In the prior art systems, the preheated saline/brackish water is supplied in parallel to all the humidifiers from the same source, i.e. through the dehumidifier/condenser. For any given temperature of the saline/brackish water, there is some heat loss prior to reaching the humidifiers due to the common source of the preheated saline/brackish water and the length of travel thereof which plays a contributing factor to the heat loss. In contrast, the MSAH-HDH desalination system 1000 minimizes any heat loss, since the preheated saline/brackish water is supplied from a closer source and maintained at relatively higher temperature than conventional systems. For example, the preheated saline/brackish water 1019 for the second-stage humidifier 1016 is supplied directly from the dehumidifier 1018, while the preheated saline/brackish water 1025 for the first-stage humidifier 1014 is supplied from the brine of the second-stage humidifier 1016, the brine being the remainder of the saline water that has not evaporated. In the latter case, the brine 1025 is already at an elevated temperature as a result of the humidifying process performed on the preheated seawater or brackish water 1019 from the dehumidifier/condenser 1018. Due to the above, the preheated saline water is at a higher temperature than in the conventional system. This translates to a smaller temperature difference to overcome in order to humidify the incoming air in the first-stage humidifier 1014, thereby making the process more energy efficient by reducing energy consumption required to reach the desired temperature for maximal evaporation in the humidifiers.

As the brine 1025 circulates from the second-stage humidifier 1016 to the first-stage humidifier 1014 for further humidification, the resultant brine is collected in one place, viz., the first-stage humidifier 1014. The collected brine 1017 flows in to a collection tank, such as the brine tank 1020, via gravity. In this closed-loop system, the brine tank 1020 holds the brine 1017 from the humidifiers 1014, 1016, as well as the main supply of saline water to be processed, such as seawater. Since the seawater will be at a much lower temperature than the brine, mixing of both will also significantly lower the temperature of the brine 1017. This forms the main saline water supply 1021 piped into the dehumidifier/condenser 1018.

In the dehumidifier/condenser 1018, pure water vapor is separated by condensation from the moist air 1015. The condensation occurs through thermodynamic heat exchange between the cold incoming saline water supply 1021 and the incoming hot, humid air 1015 from the second stage humidifier 1016. In this embodiment, the saline water supply 1021 is admitted through tubes in the dehumidifier/condenser 1018, and the hot, humid air 1015 condenses on the outside surface of the tubes. The condensed, desalinated water 1023 is collected and pumped out of the dehumidifier/condenser 1018 to an exterior holding tank. The cooled air 1011 from the condensation process cycles back to the solar collector 1012 associated with the first-stage humidifier 1014, repeating the humidifying dehumidifying process.

### DETAILED DESCRIPTION OF THE PREFERRED EMBODIMENTS OF THE INVENTION

The two main categories of thermal desalination use either heating or freezing for the purpose. The first involves evaporation and condensation, while the latter involves freezing and melting. The most commonly used technique of the two is the evaporation and condensation method. Solar stills and humidification-dehumidification (HDH) processes are among the widely used thermal desalination processes. These are capable of operating at low temperatures as a result of the differences in the quantity of water vapor in the air stream [1].

As desalination and cooling systems in general require a huge amount of energy for operation, the majority of these systems are in operation at locations where solar energy is abundant (deserts or high temperature zones). The integration of solar energy with these systems is a major advantage to provide the supply to meet the increasing demand for such systems [2].

About 60% of the entire world's desalination market employs the reverse osmosis technique, while the other half uses thermal desalination processes [3]. Solar stills are a commonly used thermal desalination process that requires a larger solar collector area due to its significantly lower gained output ratio (GOR). This is mainly due to the fact that this technique combines all processes into a single unit operating as a complete system. The processes are namely evaporation, condensation, and water heating through solar energy collection [4]. The performance of solar stills relies on solar radiation, cloud cover, ambient temperature, and wind velocity. The output of these systems may also be affected by factors such as brine depth, insulation, and vapor leakage [5].

HDH desalination systems when compared to solar stills have a significantly higher GOR, thereby requiring a comparatively smaller area for solar energy collection. The required technical support and capital investments associated with HDH desalination systems are minimal, as it involves simple mechanisms and can operate with raw water of wide-ranging quality. The maintenance procedures involved are also far less complicated [6].

HDH systems in general include components such as, heat supply systems, condensers, and evaporators along with an option for thermal storage. The process involves direct contact between warm saturated air and warm raw water allowing the air to reach a preferred humidity level, which is followed by extraction of water vapor from humid air using a condenser [7].

The main factors affecting evaporation and condensation of an HDH system are the rate of evaporation of water and condensation, and the temperature of the cooling water. The rate of evaporation of water and condensation increases with increasing amount of evaporative raw water. The condensation rate is also higher at lower cooling water temperature [8].

The extent of availability of solar radiation, expected loads, type of auxiliary energy, economic feasibility, the rate of solar energy required to substitute conventional energy used, and the required reliability are some of the main factors that affect the optimum capacity of thermal storage [9].

Latent heat storage depends on the phase changes of materials from solid to liquid, liquid to gas and vice-versa. Phase changing process is isothermal, indicating that the temperature of the storage material does not change. The phase changes are supposed to take place with controlled super heating and super cooling. This method of storage may operate within small temperature ranges and have high storage capacities with relatively low mass and volume [9].

Summers et al. [10] pointed out that a constant heating temperature and constant heat output are important for HDH cycle performance. The use of phase change materials (PCM) was shown to provide consistent air outlet temperatures through day and night. In the proposed design the PCM was placed just below the absorber plate.

The technology of thermal storage using phase change materials is considered as one of the most useful thermal storage options, due to the constant temperature in storing and releasing heat, high density of heat storage, and ease of control. Heat storage and release in this type of systems is affected by the flowrate at the inlet and outlet of the storage component. During the day time if the temperature of the collector outlet exceeds the maximum allowed temperature, additional heat is directed to the thermal storage unit [11].

Most heat storage systems use oil, water, or air as the heat transfer fluid, whereas iron, ceramic bricks, earth, water, or stones are used as the storage medium. The high heat capacity of water makes it logical to be used as a storage medium for applications that require heating and cooling, although large quantities of water are required due to its lower density. Water storage tanks are highly recommended for 24-hour operation of humidification-dehumidification desalination plants. Storage materials such as rocks or ceramics have the capability of maintaining large temperature differences; however they have a relatively low heat capacity [12].

Phase change material (PCM) may be used to store thermal energy in the form of latent heat. The energy transfer occurs when a material changes from solid to liquid and vice versa. This is called a change in state or “Phase.” The heat energy is stored during transformation of the material from solid to liquid and is discharged when the material undergoes solidification. PCM is classified as organic (e.g. paraffin, formic acid), inorganic (e.g. salt hydrates) and eutectic (e.g. triethylolethane+water+urea).

The importance of thermal storage systems combined with solar thermal desalination systems is mainly due to the variation in heat input through time dependent solar radiation. This patent introduces a unique energy storage system that uses hot and cold storage tanks as two separate storage entities to provide constant heat input for the HDH system. Such an approach is expected to smoothen the fluctuations of energy input through renewable sources, where the diurnal variations of the heat gained through collectors can introduce thermal stresses and irregular water production rates. The design proposed in this study introduces a water-heated HDH system that uses evacuated tube collectors for thermal energy collection, along with thermal storage. The humidifier and dehumidifier units used within the system use packed beds that provide a highest efficiency of about 85% for the evaporation and condensation components. Detailed thermodynamic analyses were conducted to evaluate the performance of the proposed system, with the detailed performance evaluation conducted for Dhahran, Saudi Arabia. Furthermore, the analysis was extended and the performance of the proposed system were evaluated at six different locations in Saudi Arabia.

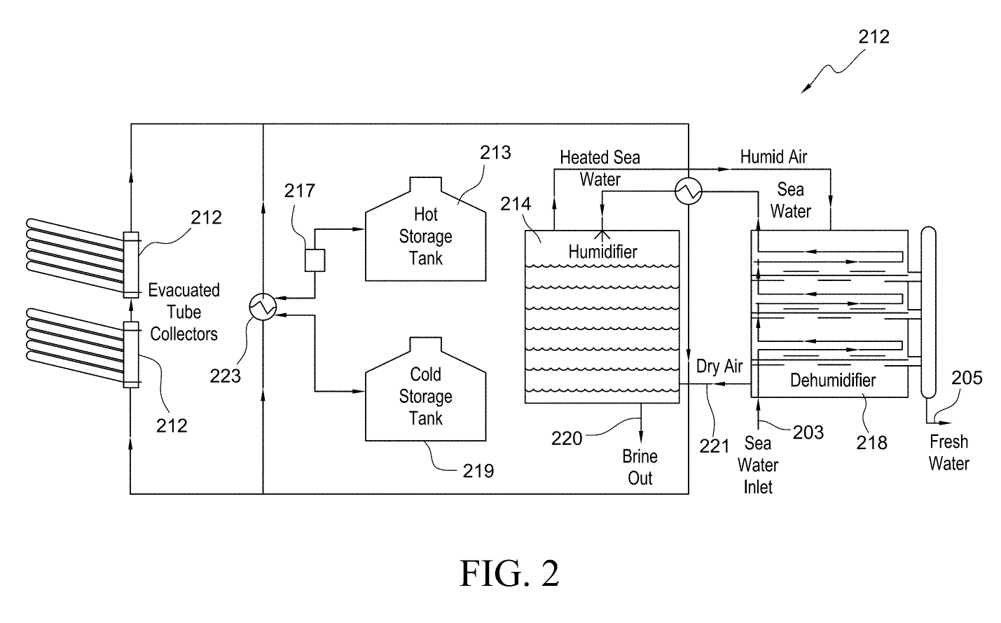

The proposed design for a closed-air/open-water (CAOW) HDH system integrated with an evacuated tube water heater and a unique thermal storage system is shown in FIG. 2. A closed-loop air system design was chosen because it has higher performance as compared to the open air HDH system. The thermal storage system is designed to provide a system with a 24-hour functional capability and fresh water production at a constant rate, by providing saline water to the humidifier at a constant temperature. Heat is added to saline water exiting the dehumidifier to maintain the constant temperature, by the combination of hot and cold storage tanks through an integrated control system. The system maintains a constant temperature as required, providing smooth operation of the desalination plant as well as controlling its operation depending on the time of day. The fluid used within the collector part of the design may have special properties in order to improve the thermal energy collection and prevent boiling or freezing. This is possible due to the use of a heat exchanger, which does not involve direct mixing with the heating fluid. The heating fluid considered in this study is water.

As illustrated in FIG. 2, a humidification dehumidification desalination system 200 in accordance with a preferred embodiment of the present invention is somewhat similar to the prior art desalination system shown in FIG. 1. For example, the preferred embodiment of the present embodiment of a desalination systems 200 include a plurality of evacuated tube collectors 212 as for example 30 evacuated tube collectors connected to a humidifier 214 and a dehumidifier/condenser 218.

The humidifier 214 directs heated seawater from a hot storage tank 213 and humidifier 214 to the dehumidifier/condenser 218. The proposed design for a closed-air/open water (C-A/OW CAOWHDH) system integrated with an evacuated tube water heater and a unique thermal storage system shown in FIG. 2. A closed-loop air system design was chosen because it has higher performance as compared to the open air HDH system. The thermal storage system is designed to provide a system with a 24-hour functional capability and fresh water production at a constant rate, by providing saline water to the humidifier at a constant temperature. Heat is added to saline water exiting the dehumidifier to maintain the constant temperature.

### Thermal Storage

Thermal storage consists of a hot storage tank and a cold storage tank, where the hot storage tank is considered as an un-stratified water storage unit. When heat is demanded by the HDH, the control system measures the hot storage tank temperature and water from the cold storage is mixed with water from the hot storage at the heat exchanger in order to provide the required temperature to the water line between the humidifier and the dehumidifier.

While the invention has been defined in accordance with its preferred embodiments, it should be recognized that changes and modifications may be made therein without departing from the scope of the appended claims.

### REFERENCES

[1] T. D. Hisham and M. Hisham, Fundamentals of Salt Water Desalination. Elsevier, 2002.
[2] P. Byrne, L. Fournaison, A. Delahaye, Y. Ait Oumeziane, L. Serres, P. Loulergue, A. Szymczyk, D. Mugnier, J.-L. Malaval, R. Bourdais, H. Gueguen, O. Sow, J. Orfi, and T. Mare, “A review on the coupling of cooling, desalination and solar photovoltaic systems,” Renew. Sustain. Energy Rev., vol. 47, pp. 703-717, 2015.
[3] H. Ettouney, “Seawater Desalination,” 2009.
[4] G. P. Narayan, M. H. Sharqawy, E. K Summers, J. H. Lienhard, S. M. Zubair, and M. a. Antar, “The potential of solar-driven humidification-dehumidification desalination for small-scale decentralized water production,” Renew. Sustain. Energy Rev., vol. 14, no. 4, pp. 1187-1201, May 2010.
[5] R. Tripathi and G. Tiwari, “Effect of water depth on internal heat and mass transfer for active solar distillation,” Desalination, vol. 173, pp. 187-200, 2005.
[6] F. a. Al-Sulaiman, M. I. Zubair, M. Atif, P. Gandhidasan, S. a. Al-Dini, and M. a. Antar, “Humidification dehumidification desalination system using parabolic trough solar air collector,” Appl. Therm. Eng., vol. 75, pp. 809-816, January 2015.
[7] A. Hassabou, Experimental and Numerical Analysis of a PCM-Supported Humidification-Dehumidification Solar Desalination System., Dessertation, Technische Universität Münche, 2011.
[8] J. Wang, N. Gao, Y. Deng, and Y. Li, “Solar power-driven humidification-dehumidification (HDH) process for desalination of brackish water,” Desalination, vol. 305, pp. 17-23, November 2012.
[9] J. A. Duffie and W. A. Beckman, Solar Engineering of Thermal Processes, 4th ed. John Wiley & Sons, 2013.
[10] E Summers, M. Antar, and J. L. V, “Design and optimization of an air heating solar collector with integrated phase change material energy storage for use in humidification-dehumidification desalination,” Sol. Energy, vol. 86, no. 11, pp. 3417-3429, 2012.
[11] S. Xu, X. Ling, and H. Peng, “Experimental of New Thermal Storage in a Desalination System,” Appl. Mech. Mater., vol. 143-144, pp. 531-535, 2011.
[12] H. Müller-Holst, M. Engelhardt, and W. Schölkopf, “Small-scale thermal seawater desalination simulation and optimization of system design,” Desalination, vol. 122, pp. 255-262, 1999.
[13] Apricus, “Product Catalog 2012 Sustainable Hot Water Solutions,” 2012.
[14] G. P. Narayan, M. H. Sharqawy, J. H. Lienhard V, and S. M. Zubair, “Thermodynamic analysis of humidification dehumidification desalination cycles,” Desalin. Water Treat., vol. 16, no. 1-3, pp. 339-353, April 2010.

What is claimed is:

1. A solar humidifier-dehumidifier desalination system for desalination of saline water, adjacent a source of seawater or the like, said system comprising:
a plurality of evacuated tubular collectors, a first storage tank for cold seawater and a second storage tank for heated seawater, a humidifier, and a condenser/dehumidifier;
pumping means for moving saline water from said source of seawater or the like to and through said solar thermal collectors for heating said saline water to a temperature within a range of between about 50° C. and 90° C. and moving said heated and humidified air from said humidifier to and into said condenser/dehumidifier;
separating and delivering desalinated water to a first outlet and hot seawater to a second outlet for preheating seawater to said hot water storage tank and returning a portion of said concentrated seawater to a disposal; and
sizing said system to maintain its operation during periods of darkness.

2. The solar humidifier-dehumidifier desalination system for desalination of saline water according to claim 1, in which hot water from said storage tank is used as a heat transfer fluid.

3. The solar humidifier-dehumidifier desalination system for desalination of saline water according to claim 1, in which said second storage tank is of sufficient capacity to provide 24 hours of continuous operation during the dark hours in a 24 hour period.

4. The solar humidifier-dehumidifier desalination system for desalination of saline water according to claim 1, in which said system includes a hybrid spray flash system combined with hot storage to reduce the costs for providing fresh water by the use of better evaporation surfaces and thinner flat plate heat exchangers; and, wherein the thickness of said plates range from 0.5 mm to 1.2 mm.

5. The solar humidifier-dehumidifier desalination system for desalination of saline water according to claim 1, in which a water humidifier-dehumidifier system uses solar thermal collectors for thermal collection along with thermal storage and wherein the system includes packed beds that provide a higher efficiency of about 85% for the evaporation and condensation components; and,
wherein said packed bed storage system consists of loosely packed solid material through which the heat transport fluid is circulated; and,
heated fluid flows into a bed of graded particles from top to bottom and transfers its thermal energy to the packed bed material during a charging phase and in which the packed bed materials include pebbles, concrete, sand and brick.)

6. The solar humidifier-dehumidifier desalination system for desalination of saline water according to claim 5, which includes 30 evacuated tube collectors.

7. The solar humidifier-dehumidifier desalination system for desalination of saline water according to claim 6, which includes a plurality of tilted solar heaters to thereby increase the performance of the humidifier impacting productivity.

8. The solar humidifier-dehumidifier desalination system for desalination of saline water according to claim 5, in which the use of phase change materials provide consistent air outlet temperatures through day and night.

9. The solar humidifier-dehumidifier desalination system for desalination of saline water according to claim 5, which includes an absorbent plate or plates and in which said phase change materials are placed just below said absorbent plates.

10. The solar humidifier-dehumidifier desalination system for desalination of saline water according to claim 1, in which the thermal storage consists of said hot storage tank and said cold storage tank and wherein said hot storage tank is an unstratified water storage unit.

11. A solar humidifier-dehumidifier desalination system for desalination of saline water, adjacent a source of seawater or the like, said system consisting of:
a plurality of evacuated tubular collectors, a first storage tank for cold seawater and a second storage tank for heated seawater, a humidifier, and a condenser/dehumidifier;
pumping means for moving saline water from said source of seawater or the like to and through said evacuated tubular collectors for heating said saline water to a temperature within a range of between about 50° C. and 90° C. and moving said heated and humidified air from said humidifier to and into said condenser/dehumidifier;
separating and delivering desalinated water to a first outlet and hot seawater to a second outlet for preheating seawater to said hot water storage tank and returning a portion of said concentrated seawater to a disposal; and
sizing said system to maintain its operation during periods of darkness.

12. A solar humidification-dehumidification desalination method for desalination of saline water, said method comprising the steps of:
providing a plurality of solar thermal collectors, a first storage tank for cold seawater and a second storage tank for heated seawater and brine, a humidifier, and a condenser/dehumidifier;
moving said saline water from said second storage tank to and through said evacuated tubular collectors for heating said saline water to a temperature within the range of between about 50° C. and 90° C. and delivering said heated and humidified seawater to and through said humidifier to and into said condenser/dehumidifier;
separating and delivering desalinated water to a first outlet and hot seawater brine to said second storage tank; and
maintaining the method over a continuous 24 hours of operations.

13. The solar humidification-dehumidification desalination method according to claim 12, in which hot water from said second storage tank is used as a heat transfer fluid.

14. The solar humidification-dehumidification desalination method according to claim 12, in which said second storage tank is of sufficient capacity to provide 24 hours of continuous operation during the dark hours of a 24 hour period.

15. The solar humidification-dehumidification desalination method according to claim 12, which includes the step of using a hybrid spray flash system combined with hot storage to reduce the cost for providing freshwater of the use of better evaporation services and thinner plate heat exchangers.

16. The solar humidification-dehumidification desalination method according to claim 12, in which any overheated water in excess above the heat range of claim 12 is delivered to said second storage tank said method includes the use of a hybrid spray flash system combined with hot storage to reduce the cost for providing freshwater because of better evaporation surfaces and thinner flat plate heat exchangers.

17. The solar humidification-dehumidification desalination method according to claim 12, in which the solar heater is complimented with a separate electric heater.

18. A solar humidifier-dehumidifier desalination system for desalination of saline water, adjacent a source of seawater or the like, said system consisting of:
a plurality of collectors, a first storage tank for cold seawater and a second storage tank for heated seawater, a humidifier, and a condenser/dehumidifier;
pumping means for moving saline water from said source of seawater or the like to and through said collectors for heating said saline water to a temperature within a range of between about 50° C. and 90° C. and moving said heated and humidified water from said humidifier to and into said condenser/dehumidifier;
separating and delivering desalinated water to a first outlet and hot seawater to a second outlet for preheating seawater to said hot water storage tank and returning a portion of said concentrated seawater to a disposal; and
sizing said system to maintain its operation during periods of darkness.

19. A solar humidification-dehumidification desalination method for desalination of saline water, said method consisting of:
providing a plurality of collectors, a first storage tank for cold seawater and a second storage tank for heated seawater and brine, a humidifier, and a condenser/dehumidifier;
moving said saline water from said second storage tank to and through said collectors for heating said saline water to a temperature within the range of between about 50° C. and 90° C. and delivering said heated and humidified seawater to and through said humidifier to and into said condenser/dehumidifier;
separating and delivering desalinated water to a first outlet and hot seawater brine to said second storage tank; and
maintaining the method over a continuous 24 hours of operations.
